(19) United States
(12) Patent Application Publication
(10) Pub. No.: US 2016/0318011 A1
(43) Pub. Date: Nov. 3, 2016

(54) CERAMIC-BASED CATALYST AND A METHOD FOR SYNTHESIZING THE SAME

(71) Applicants: Abdurahman Hosseinifar, Isfahan (IR); Maryam Fakhraie Farouji, Isfahan (IR)

(72) Inventors: Abdurahman Hosseinifar, Isfahan (IR); Maryam Fakhraie Farouji, Isfahan (IR)

(21) Appl. No.: 15/211,726

(22) Filed: Jul. 15, 2016

Related U.S. Application Data
(60) Provisional application No. 62/207,907, filed on Aug. 20, 2015.

(51) Int. Cl. B01J 37/06; B01J 35/04; B01J 37/16; B01J 23/44; B01J 37/02

(52) U.S. Cl. CPC B01J 37/06; B01J 23/44; B01J 37/0225; B01J 37/0236; B01J 37/16; B01J 35/04

(57) ABSTRACT

Provided is a method for synthesizing a ceramic-based catalyst including the steps of: purifying a ceramic foam by immersing the ceramic foam in hot water to form a clean substrate; activating the clean substrate by immersing the clean substrate in an etching solution to form an activated substrate; forming a first metal layer onto the activated substrate to form a metal-loaded substrate; and substituting the first metal layer with a noble metal layer by immersing the metal-loaded substrate in an acidic solution including a noble metal precursor to yield the ceramic-based noble metal catalyst.

### CROSS REFERENCE TO RELATED APPLICATION

The present application claims priority from pending U.S. Provisional Patent Application Ser. No. 62/207,907, filed Aug. 20, 2015, entitled “CERAMIC-BASED NOBLE METAL CATALYST FOR ULTRASOUND ASSISTED REACTIONS AND A METHOD FOR SYNTHESIZING THE SAME”, which is incorporated by reference herein in its entirety.

### TECHNICAL FIELD

The present application generally relates to ceramic-based catalysts, and particularly to a method for synthesis of a ceramic-based catalyst, and more particularly to a method for synthesis of a ceramic-based catalyst loaded with a noble metal, which is appropriate for use in ultrasound-assisted reactions.

### BACKGROUND

Noble metals and their compounds are widely used as catalyst in oxidation and reduction processes with various applications in petrochemical, pharmaceutical and chemical industries. These materials can be utilized in different processes with a variety of forms and compositions depending on the design of each particular process.

Recently, ultrasound-assisted reactions have attracted a lot of attention, due to the elimination of toxic or hazardous reagents. In general, in ultrasound-assisted reactions, in-situ generation of reactive species is carried out in the presence of ultrasound waves with a precursor that is commonly a solvent, such as water. Water molecules, for instance, break down to hydroxyl and hydrogen radicals during ultrasound-induced water dissociation, which can be later used for oxidation or hydrogenation of different chemicals.

Noble metals can be used as catalysts to accelerate the dissociation of water molecules in the presence of ultrasound waves. It can be useful to increase the active surface area, as well as active sites on noble metal catalysts. On the other hand, a method or technique for recovering the expensive noble metals at the end of the process can also improve the applicability of noble metal catalysts.

Considering the nature of ultrasound waves and their interaction with different materials, there is a need to provide a catalyst for ultrasound-assisted reactions which can be capable of withstanding the ultrasound waves, such that the minimum substrate destruction takes place at the end of the reaction or the immobilization quality of the noble metals remains unchanged. Especially from an industrial point of view, the expansion of the applications of industrialized sonication probes with high power radiations necessitates the use of resistant catalysts and substrates.

### SUMMARY

In one general aspect, a method for synthesizing a ceramic-based noble metal catalyst is disclosed. The method includes steps of: purifying a ceramic foam by immersing the ceramic foam to form a clean ceramic substrate; activating the clean substrate to form an activated substrate; forming a first metal layer onto the activated substrate to form a metal-loaded substrate; and substituting the first metal layer with a second metal layer, which is a noble metal layer, to obtain the ceramic-based noble metal catalyst. Furthermore, in certain examples, the method may further include washing the obtained product after each step to remove the unreacted or unbound or unadsorbed species.

The above general aspect may include one or more of the following features. The purifying step may include immersion of a ceramic foam in hot water for a few minutes. In certain examples, the ceramic foam may be immersed in the hot water for at least 10 minutes. The clean substrate may be activated by immersion in an etching acidic solution. In certain examples, the etching solution may be a nitric acid solution, or a hydrofluoric acid solution, or a sulfuric acid solution, or a hydrochloric acid solution, and may have an acid concentration in a range of about 0.1% wt to 2% wt. In certain examples, the first metal layer can be formed on the activated substrate through a two-stage process including metal ion adsorption and reduction on the activated substrate. Finally, the noble metal layer may formed onto the ceramic substrate via substitution instead of the formed first metal layer. The noble metal layer can be substituted via immersion of the metal-loaded substrate in an acidic solution of noble metal precursor.

The noble metal precursor used in the present application, can be any chemical compound including a noble metal, such as, but not limited to, palladium nitrate, or silver nitrate, or platinum chloride, or rhodium chloride, or gold cyanide, or chloroauric acid. In certain examples, the acidic solution of noble metal may include an aqueous solution including sulfuric acid, or nitric acid, or hydrogen chloride.

The ceramic-based noble metal catalyst of the present application may include a two-layer structure of a ceramic substrate layer loaded by a noble metal layer. In certain examples, the ceramic substrate can be supplied as commercial ceramic foam made of Zirconia (ZrO₂), or Alumina (Al₂O₃), or Silica (SiO₂), or Silicon Carbide (SiC), or any other ceramic materials. The ceramic foam can be in any commercial available forms of cubic, or cylindrical, or granulated, etc. The noble metal layer can be selected from the noble metal elements, such as, but not limited to, palladium (Pd), or silver (Ag), or platinum (Pt), or Rhodium (Rh), or gold (Au). The noble metal layer is strongly formed on the substrate layer within the prepared catalyst structure of the present application.

In another general aspect, the ceramic-based noble metal catalyst prepared pursuant to the method disclosed in the present application, can be used for catalytic reactions assisted by high ultrasonic waves. In certain examples, about 95% or more of the noble metal remains adsorbed on the ceramic foam after ultrasound waves with power greater than or equal to 500 watts have been applied to the catalyst. In certain examples, the prepared ceramic-based noble metal catalyst of the present application is capable of withstanding high power ultrasound waves without undergoing substantial structural destruction or substantially losing the catalytic activity. Accordingly, a series of analysis methods and techniques are considered to prove the stability of catalyst against high power ultrasound waves.

### BRIEF DESCRIPTION OF THE DRAWINGS

FIG. 1 illustrates an example method for preparation of a ceramic-based noble metal catalyst pursuant to the teachings of the present application.

FIG. 2 illustrates a schematic of an example ceramic-based noble metal catalyst prepared pursuant to the teachings of the present application.

FIG. 3A illustrates a scanning electron microscope (SEM) image of an example zirconia (ZrO₂) ceramic coated with a layer of Palladium (Pd), described in more detail in connection with example 1.

FIG. 3B illustrates a scanning electron microscope (SEM) image of a single strut cross section of an exemplar zirconia (ZrO₂) ceramic coated with a layer of Palladium (Pd), described in more detail in connection with example 1.

FIG. 4 illustrates the surface morphology of an exemplar zirconia ceramic (ZrO₂) coated with a palladium (Pd) layer, described in more detail in connection with example 1.

FIG. 5 illustrates X-ray powder diffraction (XRD) pattern of an exemplar zirconia (ZrO₂) ceramic foam coated with a palladium (Pd) layer, described in more detail in connection with example 2.

### DETAILED DESCRIPTION

The following detailed description is presented to enable a person skilled in the art to make and use the application. For purposes of explanation, specific nomenclature is set forth to provide a thorough understanding of the present application. However, it will be apparent to one skilled in the art that these specific details are not required to practice the application. Descriptions of specific applications are provided only as representative examples. Various modifications to the preferred implementations will be readily apparent to one skilled in the art, and the general principles defined herein may be applied to other implementations and applications without departing from the scope of the application. The present application is not intended to be limited to the implementations shown, but is to be accorded the widest possible scope consistent with the principles and features disclosed herein.

The present application generally relates to a method for synthesizing a ceramic-based noble metal catalyst that may be capable of withstanding high power ultrasound waves without undergoing substantial structural destruction or losing its activity. The ceramic-based noble metal catalyst can include an active catalytic layer of a noble metal deposited on a ceramic foam as the catalyst substrate. In certain examples, the ceramic foam may be a ceramic foam filter, such as ZrO₂ ceramic foam filter.

Noble metal based catalysts have been used for ultrasound-assisted reactions. In order to increase the catalytic sites of catalyst and then maximizing the efficiency, the noble metal, for example Palladium (Pd) was used as a suspension or it was deposited on nanoparticles. But, in these methods the catalyst may not be completely separated from products at the end of the reaction and it may undergo structural destruction or it may lose its activity because of high power ultrasound waves.

A method is disclosed for preparation of a ceramic-based noble metal catalyst that is suitable for ultrasound-assisted reactions. In certain examples, the ceramic-based noble metal catalyst may have desired characteristics such as a high surface area while withstanding high power ultrasound waves without undergoing substantial structural destruction or losing substantial catalytic capability or activity. In certain cases, the method may be used for large-scale production of the ceramic-based noble metal catalyst.

The ceramic-based noble metal catalyst can be fabricated via a method including the steps of: first, purifying a ceramic foam to form a clean ceramic substrate; second, activating the surface of the clean substrate to form an activated ceramic substrate; third, forming a first metal layer onto the activated substrate to form a metal-loaded substrate; and fourth, substituting the first metal layer with a second metal layer that is a noble metal layer to yield the ceramic-based noble metal catalyst. The step of purifying may include cleaning and removing the impurities of the ceramic foam, and may include immersing the ceramic foam in hot water. In certain cases, in the step of purifying, substantially all impurities may be removed. In other cases, some of the impurities may be removed. In the step of activating, the activated ceramic substrate may be a surface activated ceramic substrate.

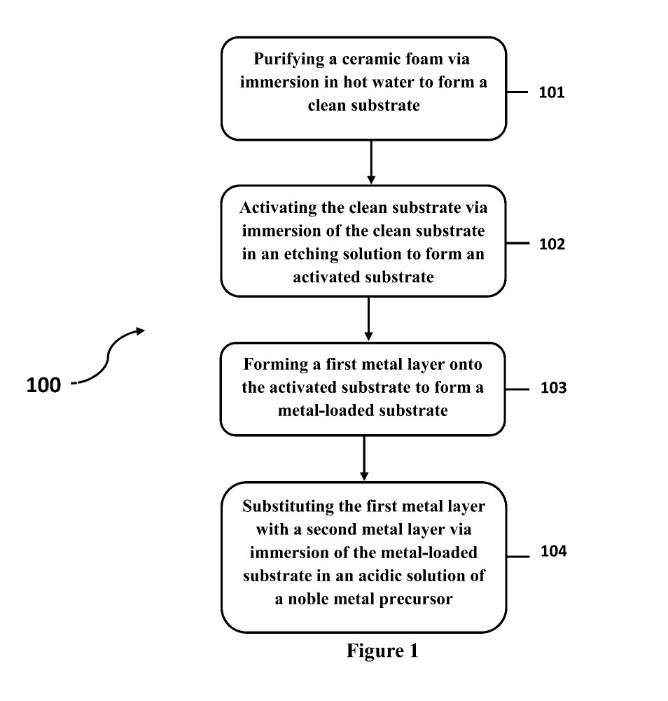

FIG. 1 shows an example process for preparation of the ceramic-based noble metal catalyst disclosed in the present application as described above. In the first step 101, a ceramic foam, which can be commercially or industrially available to supply, is cleaned or purified as the catalyst substrate. For this purpose, the ceramic foam is immersed in hot water for a certain amount of time. In certain cases, the water temperature can be in a range of about 50° C. to about 95° C. The immersion duration depends on the purity of the ceramic foam, but in certain cases, the duration is at least 10 minutes. The ceramic foam can be immersed in hot water more than once.

In one implementation, the ceramic foam can be made of ceramic materials such as, for example, Zirconia (ZrO₂), Alumina (Al₂O₃), silica (SiO₂), or Silicon Carbide (SiC). Additionally, the ceramic foam can be in any commercially available forms of cubic, or cylindrical, or granulated, etc.

The second step 102 involves activating the surface of the cleaned substrate obtained from step 101 through immersion of the clean ceramic foam in an etching solution. In certain cases, the etching solution can be, for example, a diluted nitric acid solution, a hydrofluoric acid solution, or a sulfuric or a hydrochloric acid solution with a concentration range of, for example, about 0.1 wt % to about 2 wt %. Etching duration depends on the material and the purity of the ceramic. In some examples, the clean substrate is immersed for a minimum 30 minutes etching at room temperature. In certain cases, the ceramic activated via the etching process is then washed with distillated hot water to remove the residual acid.

The third step 103 involves forming a first metal layer onto the activated ceramic foam obtained from step 102. In certain cases, step 103 may include a first sub-step of causing adsorption of a metal ion layer onto the activated ceramic foam surface and a second sub-step of reducing the metal ion layer to form a metal-loaded ceramic foam substrate.

In one implementation, the adsorption of a metal ion layer is done by immersing the activated substrate obtained from step 102 in a metal ion solution to form a metal ion-adsorbed substrate. The metal ion solution can be, for example a Cu²+ solution with a Cu²+ concentration range of about 0.5 g/L to a saturated level. In certain cases, the Cu²+ solution can be prepared from copper (II) salts, such as, but not limited to, CuSO₄, Cu (NO₃)₂, CuCl₂. In some implementations, the temperature of Cu²+ solution can be about 25 C to about 95 C and the immersion time can be about 5 minutes to about 60 minutes. In certain examples, the temperature of the solution is kept constant during the immersion. Then, in some examples, the metal ion-adsorbed ceramic is taken out and washed several times with hot distillated water to remove the unreacted or unbound or unabsorbed species.

Then, in certain examples, in the second sub-step of step 103, the metal ion layer adsorbed onto the ceramic foam substrate is reduced. Accordingly, in those examples, the metal ion-adsorbed substrate is immersed in a reducing solution to form a metal-loaded substrate.

In one implementation, the reducing agent can be a hydrazine sulfate or a hydrazine hydrate solution to form the first metal layer, for example, copper (Cu) layer which is formed by reducing the adsorbed Cu²+ layer formed as a result of the first sub-step of step 103. In certain examples, the concentration range of the reducing agent can be about 0.5 g/L to a saturated level. In some examples, the temperature of the reducing solution can be from about 40 C to about 95° C., and the immersion time in the reducing solution can be from a few seconds up to about 20 minutes. In certain cases, the immersion time in the reducing solution may be from about 5 seconds to about 20 minutes. The metal-loaded ceramic foam is then taken out of the solution, and in some cases the color of the ceramic foam may be red due to the formation of copper. In certain cases, the metal-loaded ceramic foam may then be washed several times with boiling distillated water to remove the unreacted reagents.

The fourth or final step 104 involves substituting the first metal layer loaded onto the ceramic substrate at the end of step 103 with a noble metal layer. Therefore, the metal-loaded ceramic foam obtained from step 103 is immersed in an acidic solution including a noble metal precursor to yield a ceramic-based noble metal catalyst. Then, in certain examples, the noble metal-loaded ceramic is taken out, washed several times and dried in a vacuum oven.

In certain examples, in order to prepare the acidic solution used in step 104, which includes a noble metal precursor, a solution of an acid is prepared, and then a solution including a noble metal precursor is dissolved in the acidic solution. In some examples, the prepared acidic solution can have a pH value of about 3. The noble metal precursor can be any chemical compound containing a noble metal, such as the noble metal salts. In certain examples, the noble metal precursor can be palladium nitrate, or silver nitrate, or platinum chloride, or rhodium chloride, or gold cyanide, or chloroauric acid. In some cases, the acid solution can be an aqueous solution of sulfuric acid, or nitric acid, or hydrogen chloride. Furthermore, the noble metal concentration in the acidic solution can be in a range of about 1 g/L to about 12 g/L in certain cases.

During step 104, the metal-loaded ceramic substrate obtained at the end of step 103 is immersed in the acidic solution, which is prepared as described above. In certain examples, the immersion time of the metal-loaded ceramic substrate in the acidic solution can be in a range of about few seconds to a few minutes. In certain examples, it can be in a range of about 5 seconds to about 5 minutes. In certain cases, the temperature of the prepared acidic solution can be maintained in a range of about 30° C. to about 55° C.

In one implementation, the color of the ceramic foam may change when the layer of noble metal is substituted during step 104 for the previously loaded (first) metal layer at the end of step 103. For example, the ceramic foam color may change to dark gray from red by substitution of Palladium (Pd) for copper (Cu). Then, in certain examples, the noble metal-loaded ceramic is taken out and washed several times with distillated water and dried in vacuum oven at a temperature of about 80° C.

In another implementation, the prepared ceramic-based noble metal catalyst may have a two-layered structure, including: a ceramic substrate; and a catalytic layer of a noble metal formed on the substrate. The ceramic substrate may be a ceramic foam, for example Zirconia (ZrO₂), or Alumina (Al₂O₃), or silica (SiO₂), or Silicon Carbide (SiC) having different forms, for example cubic, or cylindrical, or granulated. The catalytic noble metal layer may be made of any of noble metals group, for example palladium (Pd), silver (Ag), platinum (Pt), Rhodium (Rh), Ruthenium (Ru), osmium (Os), iridium (Ir), or gold (Au), but is not limited to the above metals. The noble metal layer can be strongly adsorbed on the substrate layer.

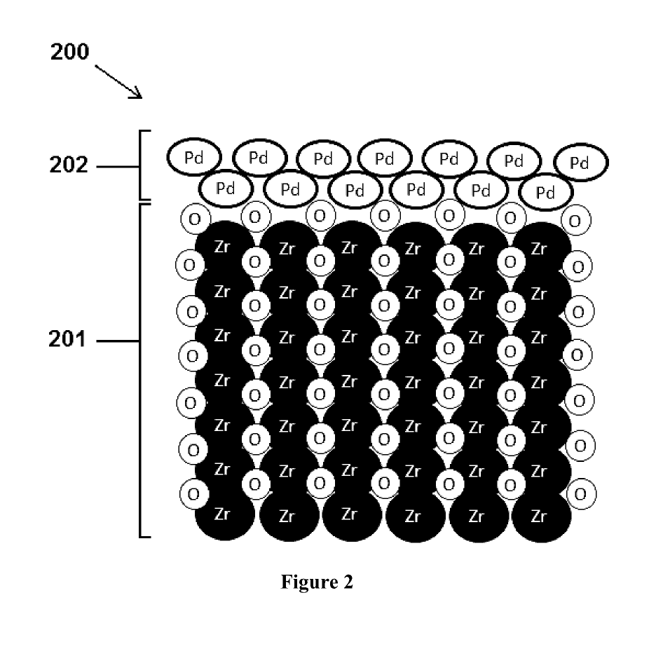

FIG. 2 illustrates a schematic structure of an example ceramic-based noble metal catalyst 200, prepared pursuant to method 100. The ceramic-based noble metal catalyst 200 represents a Zirconia (ZrO₂)-based Palladium (Pd) catalyst including: a ceramic foam substrate (for example Zirconia, ZrO₂) layer 201 loaded by a noble metal (for example Palladium, Pd) layer 202 formed on the substrate 201.

The physical and chemical stability of the ceramic-based noble metal catalyst, prepared pursuant to the method describe above, can be investigated via a sonication process using different sonication powers and durations. In some implementations, about 75% or more of the noble metal may remain adsorbed on the ceramic foam after application of ultrasound waves using an ultrasound probe with a power of about 500 watts or greater. In some cases, about 95% or more of the noble metal may remain adsorbed on the ceramic foam after application of ultrasound waves using an ultrasound probe with a power of about 500 watts or greater. In some implementations, about 99% or more of the noble metal may remain adsorbed on the ceramic foam after application of ultrasound waves using an ultrasound probe with a power of about 500 watts or greater. In some implementations, the sonication process can be done using an ultrasound probe with a power of about 750 watts with an amplitude of about 80 percent, and more than about 75% of the noble metal may remain adsorbed on the ceramic foam. In addition, the sonication duration can be applied up to about 2 hours, though not limited thereto, with excellent results.

### EXAMPLE 1

### Synthesis of the Zirconia-Based Palladium Catalyst (Pd/ZrO₂)

In this example, the zirconia-based Palladium catalysts (Pd/ZrO₂) were synthesized through the following consecutive steps. First of all, the commercially supplied ZrO₂ ceramic foam filters were cleaned by immersion in hot water with a temperature of about 70 C for about 10 minutes (an example of step 101). Then, the clean ZrO₂ foams were immersed in an etching solution, a diluted nitric acid solution with a concentration of about 2 wt % for about 30 minutes (an example of step 102). The samples were then washed with distillated hot water to remove the residual acid. Then, the ZrO₂ foams were immersed in a CuSO₄ solution with a Cu²+ concentration of about 0.5 g/L for about 20 minutes (an example of step 103, first sub-step). During the immersion, the temperature of the solution was kept constant at about 70° C. After that, the samples were taken out and washed several times with hot distillated water to remove the unbounded/unabsorbed species. Then, the samples were immersed in a saturated solution of a reducing agent, a hydrazine sulfate solution for about 5 minutes (an example of step 103, second sub-step). The temperature of the reducing solution was about 55° C. The samples were then taken out of the solution, and the color of the samples tended to red due to the formation of copper layer. The samples were then washed several times with boiling distillated water to remove the unreacted reagents. Finally, the ceramic filters with copper coated layer were immersed in an acidic solution having a pH value of about 3 containing palladium nitrate with a concentration of about 1.5 g/L (an example of step 104). In order to prepare the solution containing palladium nitrate, at first, a solution of 0.1 N sulfuric acid was prepared, and then the palladium solution was prepared using the acidic solution. The immersion time was about one minute while the solution was maintained at a temperature of about 40° C. During the immersion, a layer of palladium formed on the ZrO₂ substrate because of a chemical competition between Pd²+ and Cu(O). At the end of reaction, the color of ceramic foam filter tended to dark gray. Then, the samples were taken out and washed several times with distillated water and dried in vacuum oven at 80° C.

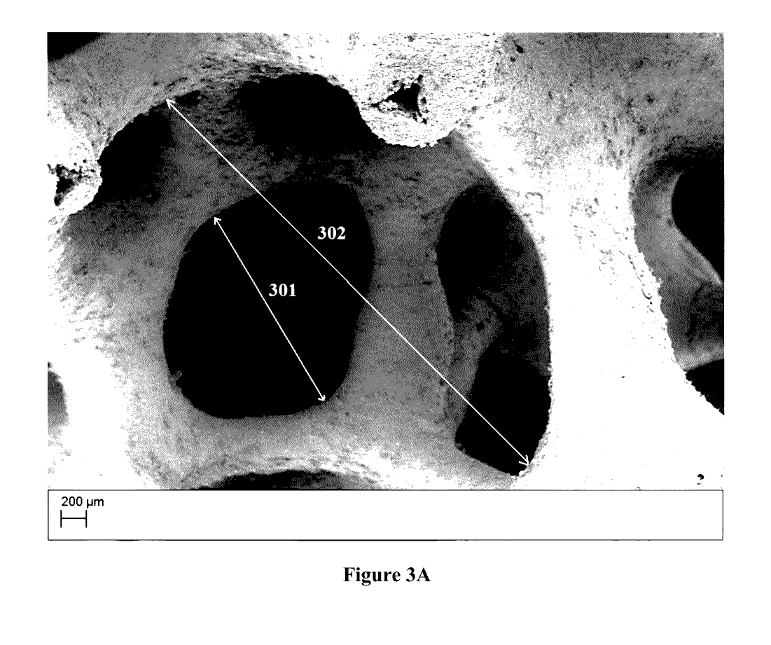

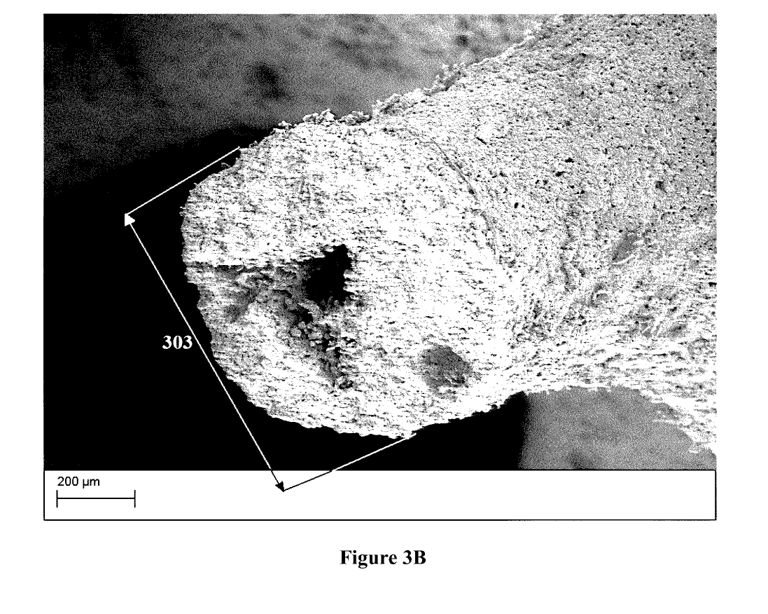

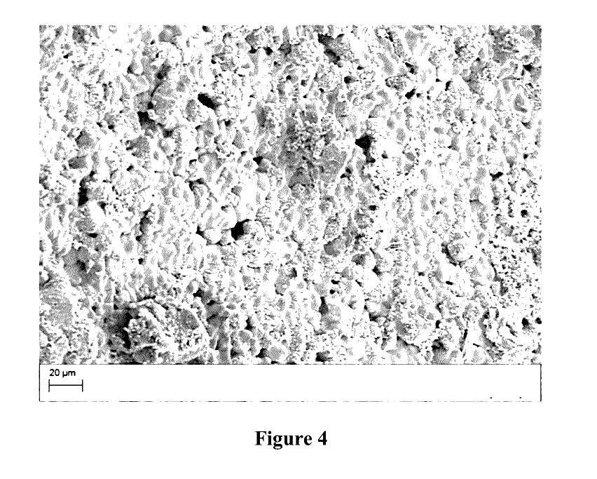

FIGS. 3A-3B and FIG. 4 illustrate SEM micrographs of zirconia ceramic catalyst substrate loaded with a layer of palladium, prepared according to Example 1.

FIG. 3A illustrates the porous structure of zirconia as the catalyst substrate and a thin layer of palladium as the catalyst that coated on zirconia. Referring to this figure, the window diameter for the porous structure of the obtained catalyst designated by arrow 301 for each structural cell is about 1400 μm. In addition, the cell diameter, which is specified by arrow 302, is about 3000 μm, referring to this figure.

FIG. 3B shows a single strut cross section complementary to FIG. 3A with more magnification. This figure represents a thickness of the strut of about 600 μm, which is specified by arrow 303.

FIG. 4 shows the surface morphology of the formed Pd/ZrO₂ catalyst surface. The uniformly-formed grey layer of Palladium can be recognized entirely coated on the ZrO₂ substrate.

### EXAMPLE 2

### Assessment of the Stability of the Pd/ZrO₂ Catalyst Against High Power Ultrasound Waves

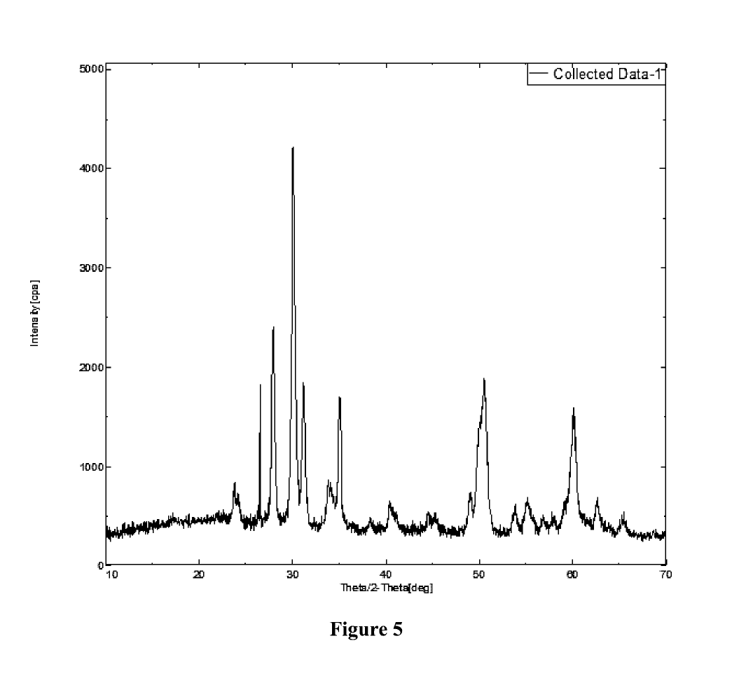

In this example, the stability of zirconia ceramic foam coated with a layer of palladium (Pd/ZrO₂), prepared according to Example 1, was investigated. A 5 cm×5 cm sample was placed in a water vessel including about 500 ml deionized water. Then, an ultrasound probe (power 750 watt power, 80% amplitude, 6 seconds pulse on and 4 seconds pulse off) was applied for about 2 hours. Every 20 minutes, sampling from solution was done and the samples were tested by Atomic Absorption Spectroscopy (AAS). The obtained results showed that Palladium or Pd²+ were not detectable in the samples. In addition, an X-ray powder diffraction (XRD) test was performed before and after this assessment, and the patterns of these tests were exactly the same which is shown in FIG. 5. This means that the catalyst compound and structure remained stable without any change during sonication so that it is capable of withstanding high power ultrasound waves without undergoing any structural destruction.

What is claimed is:

1. A method of synthesizing a ceramic-based noble metal catalyst, comprising the steps of:
purifying a ceramic foam by immersing the ceramic foam in hot water to form a clean substrate;
activating the clean substrate by immersing the clean substrate in an etching solution to form an activated substrate;
forming a first metal layer onto the activated substrate to form a metal-loaded substrate; and
substituting the first metal layer with a second metal layer by immersing the metal-loaded substrate in an acidic solution including a noble metal precursor to yield the ceramic-based noble metal catalyst,
wherein the second metal layer comprises a noble metal.

2. The method according to claim 1, further comprising drying the ceramic-based noble metal catalyst in a vacuum oven, or in an oxygen free atmosphere at a temperature of about 80° C.

3. The method according to claim 1, wherein the ceramic foam includes Zirconia (ZrO₂), Alumina (Al₂O₃), silica (SiO₂), or Silicon Carbide (SiC).

4. The method according to claim 1, wherein the ceramic foam is in a cubic, cylindrical, smooth form, or granulated form.

5. The method according to claim 1, wherein the hot water has a temperature in a range of about 50 C to its boiling point.

6. The method according to claim 1, wherein the ceramic foam is immersed in the hot water for at least 10 minutes.

7. The method according to claim 1, wherein the etching solution is a nitric acid solution, a hydrofluoric acid solution, a sulfuric acid solution, or a hydrochloric acid solution, or any mixture of the same.

8. The method according to claim 1, wherein the etching solution has an acid concentration in a range of about 0.1% wt to 2% wt.

9. The method according to claim 1, wherein the clean substrate is immersed in the etching solution for at least 30 minutes.

10. The method according to claim 1, wherein the forming the first metal layer onto the substrate includes the steps of:
causing adsorption of a metal ion layer by immersing the activated substrate in a metal ion solution to form a metal ion-adsorbed substrate; and
reducing the metal ion layer by immersing the metal ion-adsorbed substrate in a reducing solution to form the metal-loaded substrate.

11. The method according to claim 10, further comprising washing the metal ion-adsorbed substrate with distilled water after the causing adsorption of the metal ion layer, and washing the metal-loaded substrate with distilled water after the reducing.

12. The method according to claim 10, wherein the metal ion solution includes copper (II) ion (Cu²+).

13. The method according to claim 12, wherein the metal ion solution includes CuSO₄, Cu (NO₃)₂, or CuCl₂ as a solute.

14. The method according to claim 12, wherein the metal ion solution has a Cu²+ concentration range of about 0.5 g/L to a saturated level.

15. The method according to claim 10, wherein a temperature of the metal ion solution is in a range of about 25 C to about 95° C.

16. The method according to claim 10, wherein the activated substrate is immersed in the metal ion solution for a time interval in a range of about 5 minutes to about 60 minutes.

17. The method according to claim 10, wherein the reducing solution is a hydrazine sulfate solution or a hydrazine hydrate solution.

18. The method according to claim 17, wherein the concentration of the reducing solution is in a range of about 0.5 g/L to a saturated level of the hydrazine.

19. The method according to claim 10, wherein a temperature of the reducing solution is in a range of about 40° C. to about 95° C.

20. The method according to claim 10, wherein the metal ion-adsorbed substrate is immersed in the reducing solution for a time interval in a range of about 5 seconds to about 20 minutes.

21. The method according to claim 1, wherein the noble metal precursor includes a noble metal salt.

22. The method according to claim 1, wherein the noble metal precursor includes palladium nitrate, silver nitrate, platinum chloride, rhodium chloride, gold cyanide, or chloroauric acid.

23. The method according to claim 1, wherein the acidic solution including the noble metal precursor has a noble metal concentration in a range of about 1 g/L to about 12 g/L.

24. The method according to claim 1, wherein a temperature of the acidic solution including the noble metal precursor is in a range of about 30° C. to about 55° C.

25. The method according to claim 1, wherein the metal-loaded substrate is immersed in the acidic solution including the noble metal precursor for a time interval in a range of a about 5 seconds to about 5 minutes.

26. The method according to claim 1, wherein the acidic solution including the noble metal precursor has a pH value of about 3.

27. The method according to claim 1, wherein the acidic solution including the noble metal precursor is prepared by dissolving the noble metal precursor in an aqueous solution of sulfuric acid, or nitric acid, or hydrogen chloride.

28. The ceramic-based noble metal catalyst prepared according to the method of claim 1, wherein about 75% or more of the noble metal remains adsorbed on the ceramic foam after ultrasound waves with a power greater than or equal to 500 watts have been applied to the catalyst.

29. The catalyst according to claim 28, wherein the ultrasound waves have a power of about 500 watts or greater and are applied directly by an ultrasound probe, or indirectly by ultrasound bath.

30. The catalyst according to claim 28, wherein about 75% or more of the noble metal remains adsorbed on the ceramic foam when the ultrasound waves are applied by an ultrasound probe with an amplitude of about 80 percent.

31. The catalyst according to claim 28, wherein about 75% or more of the noble metal remains adsorbed on the ceramic foam when the ultrasound waves are applied by an ultrasound probe for a time interval ranging from about 5 minutes to about 2 hours.
